(19) United States
(12) Patent Application Publication
(10) Pub. No.: US 2012/0042003 A1
(43) Pub. Date: Feb. 16, 2012

(54) COMMAND AND CONTROL TASK MANAGER

(75) Inventors: Michael C. Goetz, Fort Wayne, IN (US); Robert E. Gerard, Fort Wayne, IN (US)

(73) Assignee: Raytheon Company, Waltham, MA (US)

(21) Appl. No.: 12/855,069

(22) Filed: Aug. 12, 2010

(51) Int. Cl. G06F 15/16; G06F 15/173; G06F 9/46

(52) U.S. Cl. 709/203; 718/100; 709/223

(57) ABSTRACT

A task manager for use in a multi-user, multi-organizational environment is presented. Generally, the task manager enables users of devices or networked devices or systems, e.g., client/server arrangements, in different organizations to task and be tasked across organizational boundaries. The task manager provides a user interface through which users can generate, monitor and close tasks, as well as delegate tasks, decompose tasks generating subtasks and provide status updates for tasks and subtasks. The user interface allows a task-centric view in which an originator of a task can monitor the status of the task (including any and all related subtasks). It also allows a user-centric view in which tasks assigned by and to the same user can be viewed. In the task manager a task has a format that associates it with task attributes such as task identifier and user-provided attributes including name of task originator, name of task assignee, status, title and task description. The task description may be unstructured text or a structured data representation.

### BACKGROUND

Task management techniques that coordinate work activities and share task details are known. Some task management tools are focused on individual users (such as simple “to-do” list tools), while others are oriented towards multiple users, e.g., general office “action item” tools that allow a project manager to control a particular project from the top down. These types of task management tools are limited in that they fail to capture the broader view of a collaborative effort involving inter-dependent tasks and inter-user and inter-organization coordination of tasking activities. Moreover, since such tools are primarily server-based, with a single server supporting multiple clients, they do not work well in dynamic and multi-organization environments in which processing must be distributed and communications bandwidth is limited.

### SUMMARY

In one aspect, a system includes a task manager software tool that enables a user operating in a first autonomous organization to assign tasks to and be assigned tasks by users operating in a second autonomous organization. The task manager is configured so that all instances and elements of the task manager tool in the first autonomous organization are separate and independent from those of the task manager tool in the second autonomous organization.

Embodiments may include one or more of the following features. The task manager tool may provide a user interface having entries corresponding to each task. In each entry, the task may have a format that associates the task with task attributes including task identifier and user-provided attributes. The user-provided attributes may include a task originator, a task assignee, a task status and a task description. The task manager tool may enable use of an unstructured text representation for the task description of some types of tasks, and a structured data representation for the task description of yet other types of tasks. A task description may be usable to define a task to be executed at least in part by application software available to the task assignee. The user interface may be configured to provide a view of the tasks assigned to and by the user. A task may be decomposed into subtasks, and the user interface may be configured to allow the decomposition. When the task is decomposed into subtasks, the user interface may allow the task status of the decomposed task to indicate that task's completion when all of its subtasks are completed. The task manager tool may allow a task result, or alternatively, a reference to a task result, to be made available through use of the user interface. The system can further include a node associated with the first autonomous organization that is provided with the task manager tool. The node may be configured as a client/server arrangement in which a client is coupled to a server, and software in the server may be implemented with a service oriented architecture (SOA) platform comprising a task manager service and other services. The other services may include a policy/rules service to control release of information by the organization when a task result is to be provided via the task manager tool across organizational boundaries.

In another aspect, a method of exchanging task-related information in a multi-user, multi-organization environment includes enabling a user operating in a first autonomous organization to assign tasks to and be assigned tasks by users operating in a second autonomous organization through use of a task manager. The task manager is configured so that all instances and elements of the task manager tool in the first autonomous organization are separate and independent from those of the task manager tool in the second autonomous organization.

In yet another aspect, a computer program product includes a storage medium having stored thereon instructions that when executed by a processor result in providing a task manager tool to enable users operating in a first autonomous organization to assign tasks to and be assigned tasks by a users operating in a second autonomous organization. The task manager is configured so that all instances and elements of the task manager tool in the first autonomous organization are separate and independent from those of the task manager tool in the second autonomous organization.

### BRIEF DESCRIPTION OF THE DRAWINGS

The foregoing features of this invention, as well as the invention itself, may be more fully understood from the following description of the drawings in which:

FIG. 1A illustrates an exemplary system in which a task manager tool is deployed across multiple autonomous organizations;

FIG. 1B illustrates an exemplary system in which a task manager tool is deployed across client/server arrangements of multiple autonomous organizations;

FIG. 2 illustrates an exemplary client/service arrangement in which a task manager tool is distributed across client and server;

FIG. 3 illustrates an example service oriented architecture (SOA) based software architecture to enable task management for a client/server arrangement;

FIG. 4 illustrates an example SOA for the server side of the client/server arrangement depicted in FIGS. 1B-3;

FIG. 5A illustrates an exemplary task manager tool user interface;

FIG. 5B illustrates an example task format;

FIG. 6 illustrates example task manager operations based on interactions between a task manager user as task originator and a second task manager user as task assignee;

FIG. 7 illustrates an example process that employs the task manager tool;

FIG. 8 illustrates an example architecture of a system/device configured as a client with task manager client software as shown in FIGS. 1B-2; and

FIG. 9 illustrates an example architecture of a system configured as a server with task manager server software as shown in FIGS. 1B-2.

### DETAILED DESCRIPTION

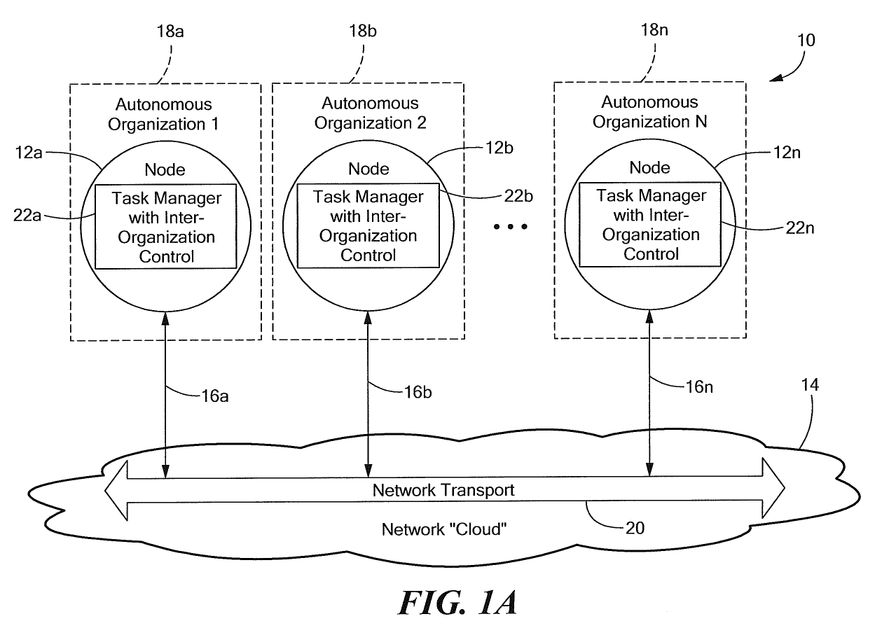

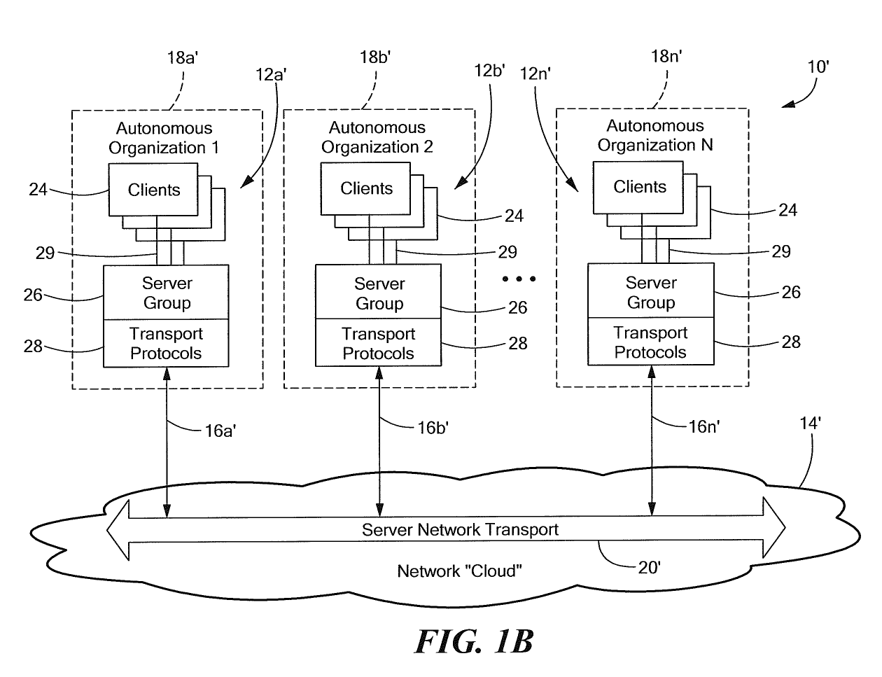

Referring to FIG. 1A, a system 10 includes one or more network nodes 12a, 12b, . . . , 12n (generally denoted 12) coupled to a communications infrastructure 14 by respective connections 16a, 16b, . . . , 16n (generally denoted 16). The network nodes 12a, 12b, . . . , 12n correspond to autonomous organizations 18a, 18b, . . . , 18n (generally denoted 18). Each node 12 is intended to represent a computing and communications infrastructure of the autonomous organization to which the node corresponds. That infrastructure can include, e.g., a network of mobile user devices, a networked arrangement of clients and servers or other arrangements of user devices and systems. The nodes 12 communicate with each other via a network transport 20 in the communications infrastructure 14.

The communications infrastructure 14, represented as a network “cloud”, can include a homogeneous or heterogeneous network environment, including public and/or private networks, or virtual private network (VPN), with various types of network equipment, media and protocols supported.

The term “autonomous organization”, as used herein, refers to an organization that operates independently, even if under control of, responsible to, or dependent on other organizations. Autonomous organizations are separable in terms of concerns and responsibilities. They determine their own course of action to achieve a goal. Examples include teams within an entity, such as finance and sales within a commercial entity, or intelligence and maneuver within a military unit, and teams across entity boundaries, such as supplier and prime for commercial retail, or multi-national forces under unified control. The autonomous organization 18 can be a military or a non-military (e.g., governmental, civilian or commercial) organization.

Each autonomous organization's node 12 is configured with task management support. The task management support enables users within an organization to task or be tasked by other such users, either within the same organization or across organizational boundaries, i.e., between networks of different organizations. Consequently, the system 10 provides an architecture through which users of different entities can collaborate, regardless of location and organization affiliations.

The task management support is shown in FIG. 1A as a task manager with inter-organization control (or task manager), which is provided in each node 12a, 12b, . . . 12n, as task manager 22a, 22b, . . . , 22n (generally denoted 22), respectively. The task manager 22 is configured with inter-organization control capability that allows instances and elements of the task manager used by users operating in one autonomous organization to be separate and independent of instances and elements of the task manager used by users operating in a different autonomous organization. For example, the task manager 22 is provided with information access and release control for security and other reasons, as will be discussed later.

The task manager facilitates communications exchanges between autonomous organizations that need to exchange tasks and task responses in order to maintain operational and competitive efficiency. As the tool may be deployed as a common capability within a node (e.g., across clients or other user devices (“user nodes”) of the same organization's network) and/or at different organization nodes, it can encompass user peers and echelons alike. Thus, the task manager allows collaborative tasking to peers, tasking by higher echelons, and requests by subordinates. It is particularly suitable for multi-echelon tactical users, e.g., military users operating in a tactical command and control operations environment. Such an environment requires multi-instance distributed processing, with the capability to coordinate between user nodes. In that environment, as well as in others, the task manager allows the users to task, be tasked, resolve tasks, and monitor the status of all tasks. The task manager can be utilized by flattened organizations as well as hierarchical multi-echelon organizations.

The software that implements the task manager will be referred to herein as a task manager or task manager tool. For military command and control applications, the task manager may be referred to as a command and control task manager (or command and control task manager tool). The task manager tool software is configured (that is, designed to operate) in such as way that when instances of the task manager tool are running on different devices or systems, all of the instances and elements of the task manager tool in one autonomous organization will be separate and independent from instances and elements of the task manager tool in other autonomous organizations.

A “task” refers to a piece of work, e.g., an activity that needs to be completed. The task manager task is defined or specified by a task originator and assigned by that task originator to a task assignee. In the task manager context, the process of specifying details of the task, that is, what the work is and who should do it, is referred to as “task generation”. The task may be completed in different ways, depending upon the nature of the task and resources available to the task assignee. For example, if the task is a request for information (such as a solution to a problem), the task completion may require a response beyond an indication of completion status, for example, the task assignee could return a data product, e.g., a document, to the task originator via the task manager, or otherwise making that data product available to the task originator. Alternatively, task completion may be communicated by an indication of a completion status only. Both the task originator and task assignee may be task manager users. Alternatively, the task assignee may have software and/or hardware that performs the task directly (without the involvement of a task manager user at the assignee end of the tasking). These and other features of the task manager will be described in further detail below.

In one exemplary embodiment, as shown in FIG. 1B, the environment 10, shown as environment 10′, has autonomous organization nodes implemented with client/server architectures. In this embodiment, each node 12 (from FIG. 1A) is shown as node 12′ and includes clients 24 and a server group 26. Each server group 26 is provided with transport protocols 28 so that servers in one server group can communicate with each other and with servers in other server groups via a server network transport 20′ in the communications infrastructure 14′. In each node 12′, the client 24 is coupled to the server group 26 by a communication link or connection 29. One suitable architecture for system 10′ is a federated server architecture. In a federated server architecture, each organization's server group 26 operates independently of the other server groups. Although independent, the server groups 26 are loosely interconnected in a “federation” and communicate with each other over the communications infrastructure 14′.

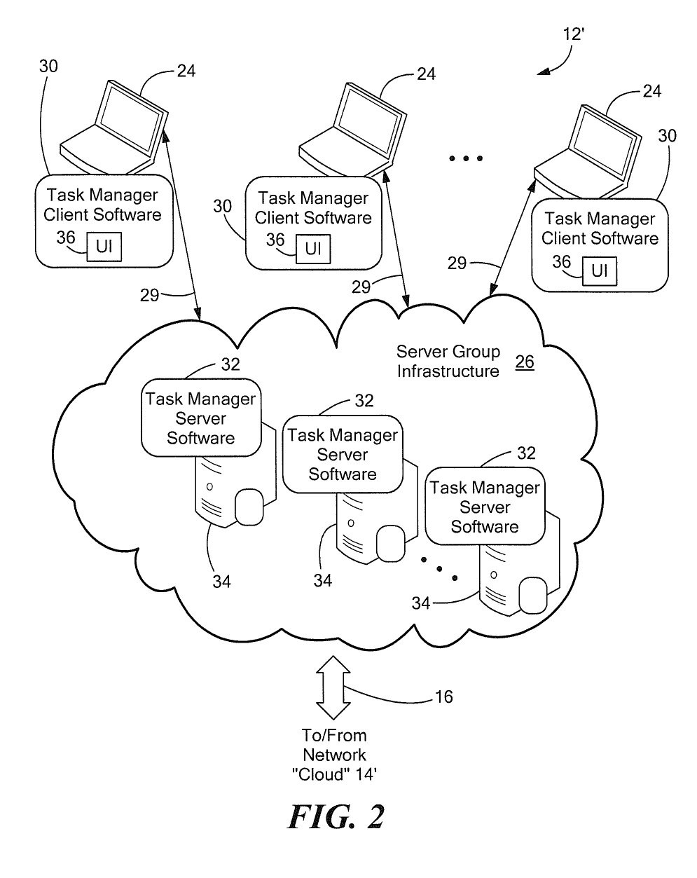

In an example client/server configuration, as shown in FIG. 2, each of the clients 24 is provided with a first task manager software portion (“task manager client software”) 30, and the server group 26 is provided with a second task manager software portion (or “task manager server software”) 32. Each server group 26 includes one or more servers. The task manager server software 32 may reside on a single server, or may be partitioned and distributed across multiple servers. Alternatively, more than one server, for example, each server 34 (as shown in the figure), may be provided with a copy of the task manager server software 32.

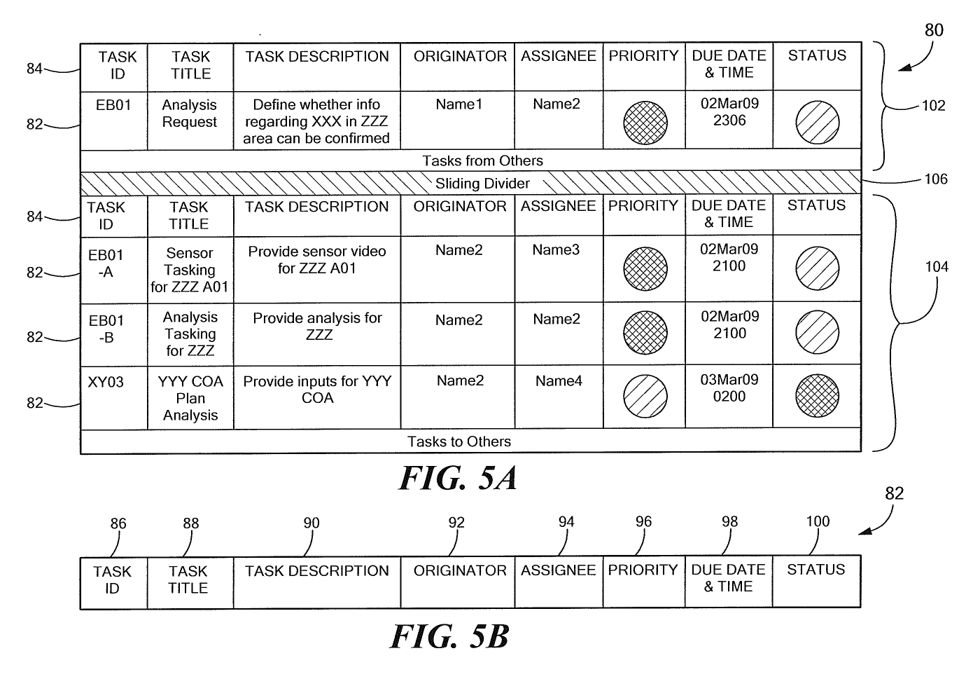

Still referring to FIG. 2, each client's task manager client software 30 includes a portal or user interface (UI) 36 through which a client user can enter, view and modify task-related information. In one exemplary embodiment, and as will be discussed in greater detail later with reference to FIGS. 5A-5B, the UI 36 can be configured to present a user with a user-centric view of the task-related information, that is, a view that is based on tasks generated by the user or issued (assigned) to the user by others.

The clients (or user nodes) 24 represent computing/communication devices that can operate in a networked environment, such as personal computers (PCs) including desktop and laptop computers, or handheld devices such as personal digital assistants (PDAs). The communications links or connections 29 include network mediums based on wireless and/or fixed network protocols. It will be understood that each user device 24 will be configured with the appropriate interface and software to implement the communications protocols used by that device. The clients 24 and their respective communications links 29 may be the same or different, that is, one client 24 could be a PC that connects to the server group 26 via a wired (or fixed) connection for link 29, while another client 24 may be a handheld device that connects to the server group 26 via wireless connections for its respective link 29. Any type of device that can be configured to use the task manager tool may be used.

Referring to FIGS. 1B-2, each server group 26 may be implemented according to different server architectures, for example, as a server cluster or as an arrangement that includes hot back-up servers, replicated servers, federated servers, a single server, or other types of server arrangements. It will be appreciated that the number of servers 34 in each server group 26 and the architecture of each server group 26 may vary from autonomous organization to autonomous organization. The server groups 26 communicate peer-to-peer (via the server network transport 20′, FIG. 1B) to exchange essential and allowed data relative to task exchange and visibility between the autonomous organizations 18′. The peer-to-peer server communications employ messaging that maintains consistency of task manager data available at each organization's network.

As is well understood in the art, client/server architectures are tiered architectures. A client/server system has several tiers or layers, which can be visualized in either a conceptual or a physical manner. Viewed conceptually, and according to one example architecture, the layers include presentation, process (or application) and database layers. In such a tiered architecture, there is a distribution of presentation services, application code, and data across the clients and servers. The client delegates organization-related (i.e., business, if commercial entity) functions or other tasks (such as data manipulation logic) to one or more server processes. Server processes respond to messages from clients. It will be understood that the other layered architectures are possible. For example, some layered architectures may include additional layers or tiers based upon other architectural needs.

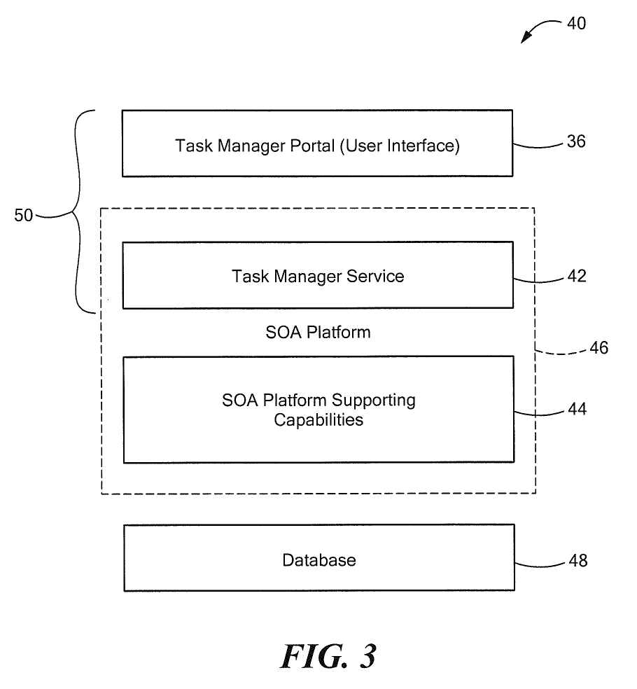

Referring to FIG. 3, a conceptual view of a client/server software architecture 40 that enables task management operation according to one exemplary embodiment is shown. The software architecture includes, on the client side, the task manager portal (or UI) 36. On the server side, the software architecture can be implemented as a Service Oriented Architecture (SOA). Thus, the server software includes a task manager service 42 and SOA platform supporting capabilities 44. The task manager service 42 (which corresponds to the task manager server software 32 from FIG. 2) and the SOA platform supporting capabilities 44 are part of an SOA platform 46. Also on the server side is the data (which includes data and metadata, in a database or other storage structure) 48. Together the task manager portal 36 and the task manager service 42 form the core of the client/server task manager software, or task manager 50. The supporting capabilities 44 include other services, capabilities and protocols software that are required for single task manager user operation and task manager user to task manager user task-related communications via the task manager and, optionally, external to the task manager. In a layered architecture such as this, the upper layers use the lower layers. For example, the task manager portal 36 uses the task manager service 42 and the task manager service 42 uses the SOA platform supporting capabilities 44.

The layered architecture depicted in FIG. 3 is only one of many possible architectures. A layered architecture that includes additional layers (as mentioned above) or different layers, or different implementation of the layers, could be used instead. For example, the server side implementation need not be based on a SOA. Also, the line of partitioning of functionality between client and server sides can be adjusted based on whether a “thin client” or “thick client” approach is desired. As a thin client approach limits the code at the client device, the client software in a thin client uses the Task Manager Portal 36 to generate its UI and does not include any task manager specific software. In contrast, with a thick client approach, the UI processing may be moved to the client side to make the client device “smarter”, and the client includes task manager specific software (i.e., Task Manager Client Software 30). Either approach can be used to implement the task manager software.

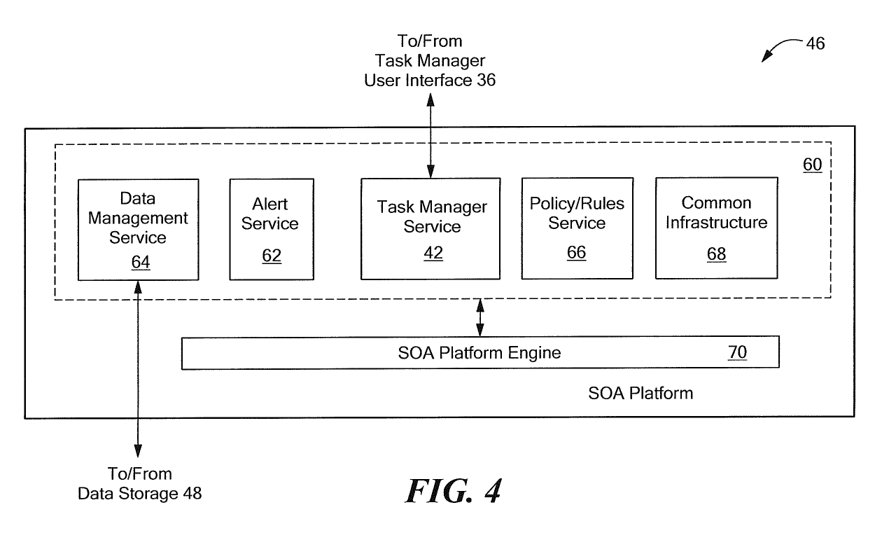

A more detailed view of the SOA platform 46 according to one exemplary embodiment is shown in FIG. 4. Turning to FIG. 4, the SOA platform 46 includes services logic 60, including the task manager service 42 and other services, such as an alert service 62, data management service 64, policy/rules service 66 and common infrastructure 68. The task manager service 42 and alert service 62 are components of the platform services. The services each define a unit of functionality, e.g., a business function. The task manager service 42 may use the alert service 62 to notify task manager users that tasks have been assigned to them or to indicate changes in task status to task manager users.

Also part of the SOA platform 46 is an SOA platform engine 70. The SOA platform engine 70 acts a backbone of the SOA platform 46, managing interfaces and messaging between the services. The SOA platform engine 70 could be implemented in different ways. For example, it could be implemented to include a workflow engine. A workflow engine would serve to couple the services to create logic flows that accomplish meaningful units of work.

The policy/rules service 66 takes input, applies rules to that input and produces decisions that control service and orchestration behaviors. The policy specifies criteria for rule evaluation. It also implements security features, for example, to provide mandatory and discretionary access control, as well as to provide release control of internal and proprietary information. As they pertain to the task manager, the policy/rules of the policy/rules service 66 could be implemented to restrict the level of information that may be communicated from task assignee to task originator, for example, when the task assignee provides information to complete a certain task. In one possible scenario involving a task exchange between peer commercial entities and a task that requires a solution in response, the tasked entity may want to provide a solution without exposing proprietary details of the solution. In another scenario, the same tasked entity (or a different tasked entity) might provide details of the solution because the details are non-proprietary and essential to task completion. The policy/rules service can also be used to control other task management related behaviors, such as whether to approve and who should approve a task completion, or actions to take when a task is overdue.

It will be understood that the SOA platform 46 can have many other services and capabilities. The illustration of FIG. 4 is intended as a simplified depiction of only those components that relate to and support task manager operation.

Referring to FIG. 5A, in one example implementation of the user interface 36 (from FIGS. 2-3), the task manager user (or operator) may be presented with a task table 80 or other suitable arrangement of task information. The task table 80 is rendered and modified by the task manager in response to user inputs. The task table 80 includes one or more entries (or rows) 82 corresponding to different tasks (including tasks that are subtasks). Each entry includes fields or portions corresponding to different columns/column headers 84.

An example format of the task (or table entry) 82 is shown in FIG. 5B. Referring to FIG. 5B in conjunction with FIG. 5A, the task 82 includes the following fields: Task ID 86; Task Title 88; Task Description 90; Originator 92; Assignee 94; Priority 96; Due Date & Time 98; and Status 100. These fields specify and correspond to different attributes of the task. The Task ID 86 is a unique identifier, for example, an alphanumeric, automatically generated by the tool. It allows a user to track the status of a particular task or subtask. The Task Title 88 is a short descriptor provided by the user. The Task Description 90 provides task details or definition, and can have different formats for different types of tasks. In one exemplary embodiment, the task description 90 can be unstructured text or structured data. The Task Description 90 is represented as unstructured text when it is entered as free-form text, as would generally be done for task types that are not supported by the task manager embodiment as codified task types, such as unusual, ad hoc, or ill-defined task types. The Task Description 90 is represented as structured data when it is entered using task manager support for a codified task type. A Task Description represented as structured data may in turn facilitate task execution by automated processing interfaced to the Task Manager and operating on behalf of the Assignee 94. Either of the two categories of task description could be used for task decomposition, but with differing assistance from the task manager. For example, decomposing a task which has a task description represented as unstructured text will generally require a human operator to generate subtasks. Decomposition of a task with a description represented as structured data may not be apparent to either the Originator or the Assignee, since the structured data may be passed to an automated system which performs the decomposition internally. For example, the structured data may be represented as Extensible Markup Language (XML) or as a binary payload. Ordinarily, the structured data will require an editor specific to each task type in order to provide a human-readable version of the data representation for the Originator or the Assignee. The Originator (or Assignor) 92 is the issuer of the task. The Assignee 94 is the receiver of the task. The Priority 96 is an indicator of priority level, e.g., high, medium or low. The priority can be indicated by text or represented as a shape (for example, a circle, as shown), symbol or icon. The representation can have a color or other attribute to indicate priority information. For example, the color red could be used to denote high priority, the color yellow a medium level priority and the color green a low priority. Other indicators, including text indicators (e.g., “high”, “medium”, low”), could also be used. The Due Date/Time 98 provides the date/time by which the task needs to be completed. The Status 100 indicates the task status. Like the priority, the status can also be represented by a text or non-text indicator. The non-text indicator can be a shape (e.g., geometric shape, symbol or icon) having a specific color or other attribute to indicate status. For example, the color red could be used to indicate that the task is overdue (that is, the due date/time provided in the Due Date/Time field has passed), the color yellow to indicate that the task is in-progress and not late, and the color green to indicate that the task is complete. Some types of status may be updated automatically, while others require manual update by a user (most often, the assignee of the task).

Thus, task manager users can use the task table 80 to create new tasks, monitor tasks and provide/update status of tasks. Creating or generating tasks can include decomposing tasks into subtasks or delegating tasks (with or without modification). For example, in the illustrated task table 80 of FIG. 5A, the task assignee of task EB01 has decomposed that task into subtasks with task IDs EB01-A and EB01-B. The same user has also generated new, unrelated task XY03. The task table can also allow the task manager user to perform other operations, such as closing tasks, rejecting task assignments, providing an indication that task completion cannot be achieved and viewing task-related alerts. These and other operations, if provided, can be initiated by the user through the use of graphical control features, e.g., tool bars, menus, tabs dialog boxes, scroll bars, and the like. For example, the task table 80 may be implemented to allow a user to generate a subtask, as well as make additional information available to the user, by ‘double-clicking’ on a task. That additional information could include, for example, comments and originating task ID (especially important for tracking original task and source). The table 80 can be further implemented to allow a user to re-order each column in each section by ‘clicking’ on the appropriate column heading.

Such graphical control features can also be used to link to external documents and applications such as e-mail, as well as support software application “plug-ins” to incorporate additional features or functionality. The documents and applications can include organizational personnel lists, which could aid in task assignment as well as successor maintenance and monitoring of tasks. The “plug-ins” could be used to provide pre-defined and structured tasks, enforce vocabulary when generating tasks, provide automated task processing capabilities, and so forth. The task manager can be connected to other task related capabilities as well.

In the example embodiment illustrated in FIG. 5A, the task entries 82 are divided into sections. A first section 102, labeled “TASKS From Others”, includes those entries for which the user's name (or other identifier associated with a user) is provided in the ‘Assignee’ field 94. A second section 104, labeled “TASKS To Others”, includes the entries for which the user's name (or other identifier) is provided in the ‘Originator’ field 92, that is, entries corresponding to task requests initiated by the user. The sections 102, 104 are separated by a sliding divider 106, which allows the relative space within the two sections to be resized.

In this manner, the task manager tool provides a view with a user focus, one that shows tasks initiated by a specific individual as well as those received by that same individual. Although not shown, a view that is task focused, that is, shows all related tasks, could be provided to the user as well.

The task table 80 is a general task interface that can be adapted to task related operations in a variety of settings. For example, a routine procedure such as a pre-flight checklist, a corporate project (e.g., product development) plan and a command and control intelligence request could all be handled with the same tool.

Unlike conventional task management approaches, which are concerned with the resolution of an atomic task without consideration for subtasks, the task manager decomposition feature allows tasking and execution of tasks and well as decomposed tasks (i.e., tasks that have been decomposed into one or more subtasks). Complete resolution of a task is tied to the completion of any and all subtasks. The task completion status is returned (and “rolls up”) to the originator of the tasks and subtasks, and provides a “degree of completeness” measure for tasks in progress.

The task manager supports unstructured (e.g., pure text, ad hoc tasks, etc.) and structured (e.g., codified tasks, checklist tasks, etc.) task descriptions. It also supports manual and automated task decomposition and execution, as well as ad-hoc tasks. Structured tasks may be sent to implementing software for completion. For example, a military command and control task such as “fire weapon X” may be sent directly to the task-performing software and/or hardware, rather than relying upon a human operator to enter the same information manually. The task performing software and/or hardware may perform task decomposition as well.

The tasks can have associated source and destination assigned categories for role and responsibility context. The task manager supports manual and automated resolution of tasks based on task type and policies.

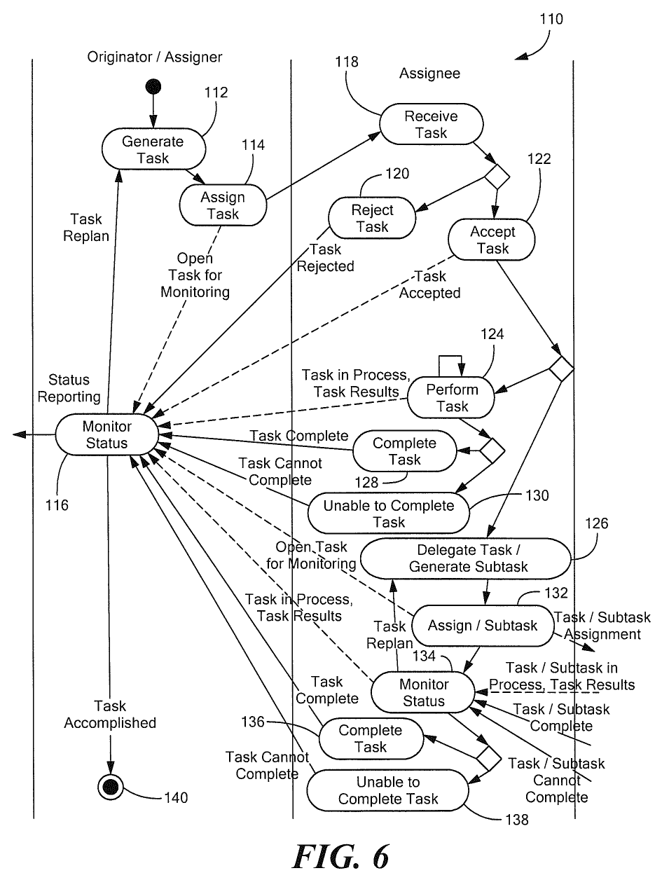

FIG. 6 depicts a representation of task manager operations 110 for a user-to-user interaction. The user-to-user interaction could be between users in different autonomous organizations (e.g., in a client/server architecture such as that shown in FIG. 1B, client-to-server-to-server-to-client interaction between a user in one autonomous organization acting as “originator” and a user in a different autonomous organization acting as “assignee” for a new task). The user-to-user interaction could also involve interaction between users of the same autonomous organization (e.g., in a client/server architecture such as that shown in FIG. 1B, interactions between user/clients in the same client/server arrangement 12′)). Both of these task manager usage scenarios are contemplated. The task manager operations 110 are intended to illustrate a range of operations available to a task manager user.

The task manager operations 110 are as follows. To begin, a task originator (or assignor) uses the task manager to generate a task (“generate task”) 112. This task generation results in a task assignment (“assign task”) 114 that assigns the task to a second task manager user, the assignee. Having assigned the task, the originator can subsequently open the task for status monitoring (“monitor status”) 116. On the assignee side, the assignee's system indicates that a task assignment is received (“receive task”) 118. Having received the task assignment, the assignee can reject the task, “reject task” 120, or accept the task, “accept task” 122. If the assigned task is rejected, the task manager will provide an indication of the task rejection from the assignee to originator. That rejection status may be available to the originator via the task manager UI or a separate alert (or other communication mechanism). If the assignee accepts the task (at 122), the assignee can perform the task (“perform task”) 124 directly, delegate the task or decompose the task generating subtasks (“delegate task/generate subtask”) 126. Referring back to 124, if the task is performed by the assignee, status updates can be provided by the assignee via the task manager. For example, the task manager will indicate that the task is in process or that the task is complete (“complete task”) 128 and provide task results. It can also indicate that the task cannot be completed (“unable to complete task”) 130. All of these status updates can be monitored by the originator (“monitor status”) 116 as they are available via the task manager UI. Referring back to 126, if the task is delegated or a subtask is generated, that task or subtask is assigned (“assign task/subtask”) 132 to a third user.

Still referring to FIG. 6, the assignee monitors status (“monitor status”) 134 to receive status reporting of the task/subtask, i.e., that the task/subtask is in process, completed or cannot be completed. If the subtask is completed, the assignee can update status to indicate that the task is completed (“task complete”) 136, which status update is monitored by the originator.

If the status reporting by the assignee of the subtask indicates that the task cannot be completed, that status is made available via the task manager (“unable to complete task”) 138. If the monitoring of status indicates that the task was completed, the originator can close the task (“task accomplished”) 140. If the task could not be completed, the originator has the option of generating a new/revised task (at 112) to start the tasking process over again.

As was mentioned earlier, a completion of a task may involve some type of response provided by the assignee to the originator. For example, the response could include a task result in the form of a data product, such as a document or report, video or audio clip, or image that the assignee generates or causes to be generated using auxiliary capabilities from the SOA platform. These other capabilities may be used in concert with the task manager capabilities. The task result could be made available to the originator via the task manager, by associating the task result with the task (e.g., embedding it in or attaching it to the task) when the assignee updates the status of the task. The originator could retrieve the task result elsewhere. As another example, the task manager result could be a structured data representation which could be used by the task originator for the automated resolution of a follow-on task. Thus, an unstructured task (e.g., “provide options”) could return one or more structured data representations (e.g., Option A, Option B, etc.) which in turn could be sent to an automated system.

In most instances, task closure will occur because the task has been completed, but other reasons for task closure are possible. For example, a task may be closed when the task has “timed out”, e.g., has an overdue status, or if the task has been overtaken by events (and is therefore no longer required). The manner in which a task is closed is a matter of user or administrator defined policy or of task manager design choice. For example, the task originator may take some action that has the effect of closing the task, such as archiving the task, accessing a task result if a task result is provided, or simply marking the task as “closed”. Alternatively, the task may close automatically, e.g., by virtue of its “complete” status, or other status or conditions.

Thus, as illustrated by FIG. 6, the task manager allows monitoring of tasks by task originators and decomposition of tasks into subtasks. It rolls up status of subtasks to parent tasks as subtasks are completed.

Other features and capabilities may be incorporated in the task manager tool as well. In particular, the use of “planned” and “prepared” tasks may be supported by the task manager. Planned tasks are tasks that are associated with a plan. Unlike the “active” tasks discussed thus far, the planned tasks are ready for use and can be activated by the task manager when conditions merit execution of the plan with which the tasks are associated. Prepared tasks are tasks that include partial pre-populated data, and so are ready for immediate use when the required additional data becomes available. As an example, a commercial entity could assign a particular vehicle for high-priority tasks in addition to its normal activities. Assignment of the vehicle for a high-priority task could be accomplished more rapidly because the vehicle to be used for the task is already known and available for the task. The existence of pre-populated data in many fields would allow rapid dissemination from a hand-held of the high-priority task both to a human operator but also to software automation Prepared tasks (or sets of tasks) may be provided as “canned” tasks (or sets of tasks) in a library. They may be used to generate planned and active tasks.

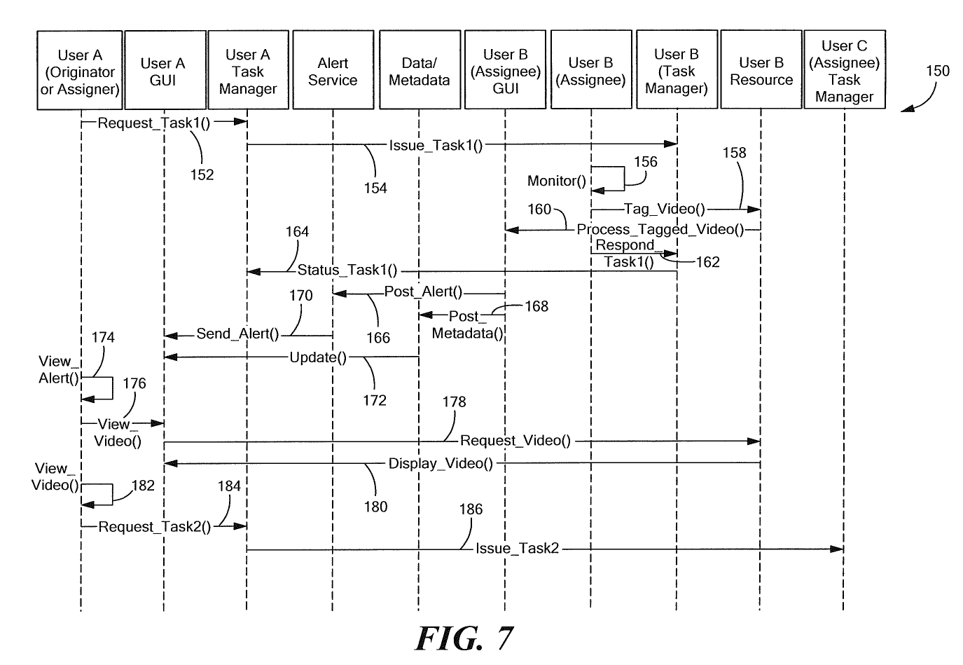

FIG. 7 shows an example process 150 that employs the task manager of multiple client/users shown as “User A”, “User B” and “User C”. In this example, a sequence of operations for process 150 occurs as follows. User A makes a task request (“Request_Task( )”) 152 to open the task manager via the task manager UI of that user's client system. The user interacts with the task manager UI to generate a task that User A assigns to a second user, User B. The task manager of User A issues that task (“Issue_Task1( )”) 154 to User B via User B's task manager UI. User B, after receiving the task assignment, executes the task. As discussed earlier, a task may be executed by a user directly, e.g., by performing an operation manually or by automatically invoking an application to perform an operation, or combining the two. In the illustrated example process, the task execution includes a monitoring activity “Monitor( )” 156, a “Tag_Video( )” operation 158 and a “Process_Tagged_Video( )” operation 160. All but the first of those three activities involve the use of a resource or application available to User B. In this example, that application is an imagery service. That service or resource returns the “Process_Tagged_Video( )” response to the GUI of User B. At this point, User B is in a position to respond by updating the status of the task in the task manager, “Respond_Task1( )” 162. The change of status in the task manager UI of User B makes the status available (“StatusTask1( )” 164) to User A via the task manager UI on User A's client system. In the illustrated example, the User B GUI also posts an alert to the Alert Service (shown as “Post_Alert( )” 166) and provides metadata related to the operations involving the imagery service to a database (shown as “Post_Metadata( )” 168). The Alert Service sends an alert (“Send_Alert( )”) 170 to the GUI of User A. The data management service provides an update (“Update( )”) 172 to the GUI of User A.

Still referring to FIG. 7, User A views the alert (“View Alert( )”) 174 and makes a request (via the GUI, “View_Video( )”) 176 to the User B resource to view the video (“Request_Video( )”) 178. The User B resource provides the requested video for display on the GUI of User A (“Display_Video( )” 180. User A views the video (“View_Video( )”) 182.

Although the illustrated interaction depicts User B making a particular result (a video) available to User A outside of the task manager tool using other capabilities of the system, other interactions may be different. That is, and as was discussed earlier, the task manager could be used to pass a task result from assignee to originator. For example, User B could prepare a report (with or without using other resources and capabilities) and embed that report with the task manager task. Thus, auxiliary capabilities of the SOA platform (in an SOA based system) and resources may be used in concert with the task manager capabilities to streamline the exchange of task-related information. Alternatively, or in addition, the assignee may include in the task manager task a reference to the task result, e.g., a description and location, so that the originator is aware of the availability of a task result. This could be done even if another form of notification, such as an alert, is used. For example, and referring back to “Status_Task1( )” 164, User B could update the task manager task to include a reference to the video so that this information accompanies the task status.

Still referring to FIG. 7, User A makes a second task request (“Request_Task2( )”) 184, this time to a second user/assignee shown as User C. As was the case with the first requested task, User A enters the task details and task assignment in the UI of User A's task manager. The task manager of User A issues the task (“Issue_Task2( )” 186 to the task manager of User C. Although not shown, User C can respond in a number of ways, e.g., execute the task, delegate the task, decompose the task generating subtasks, reject the task, and so forth, as appropriate based on the type of task assigned to User C.

It may be desirable to bypass the human operator, e.g., User C, who might otherwise be required to initiate task execution, in some applications. If the task is performed entirely by software or combination of software and hardware, the task manager could be implemented to allow the task to be sent directly to the task-performing software. In this case, the task manager client assignee/user will not be a human operator but a piece of software or software/hardware combination.

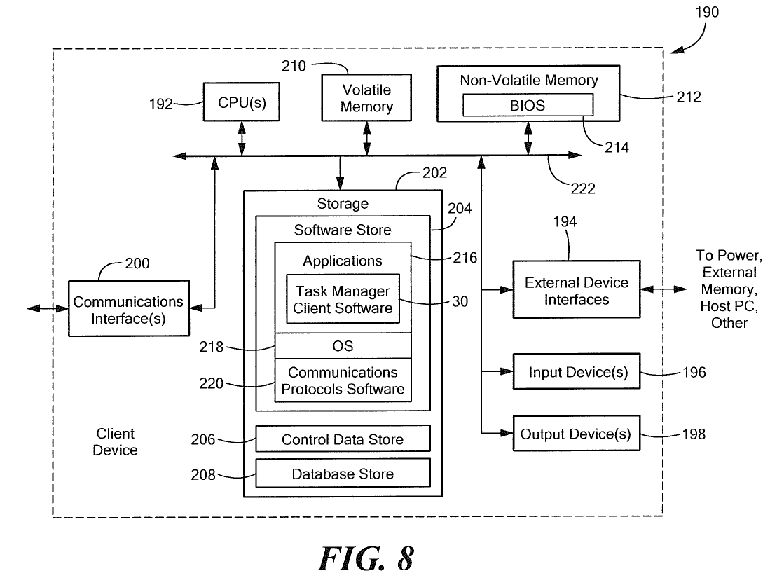

Referring to FIG. 8, one exemplary system for implementing the client side of the task manager includes a device such as device 190. The device 190 may be a handheld device, laptop computer, PC or other user-operated device or system. In a very basic configuration, the device 190 includes at least one processing device, for example, one or more processors (e.g., CPUs) 192. Also included are various interfaces, including external device interfaces 194 to allow connections to external power devices, memory, host PCs, and other devices, as well as user I/O interfaces such as input device(s) 196 (e.g., data entry interface such as keys, mouse, touch panels, voice input device, etc.) and output device(s) 198 (e.g., display, speakers, etc.). The interfaces can also include interfaces that enable transfer of software and/or data to the device from external (removable) computer readable media or from the device to such media.

Other interfaces include network hardware or communication interfaces 200 (to enable the device to connect to and communicate with the server group, from FIG. 1). The device 190 is provided with: computer readable media in the form of hard disk storage 202 to store software (“software store”) 204, control data store 206 and database store 208; volatile memory 210; and nonvolatile memory 212 to store BIOS 214. The software 204 includes applications 216, operating system 218 and communications protocols software 220 to support network communications. The applications 216 would include the task manager client software 30 (from FIG. 2) as well as other UI software and application programs. The software 204 would be copied to the volatile memory 210 (or internal processor memory) for subsequent execution by the processor 192. Such a device may have additional features or functionality. The various functional blocks of the device 190 are coupled to an internal bus structure, shown here in simplified form as interconnect 222. The internal bus architecture could be implemented any number of ways according to design requirements and known bus design techniques.

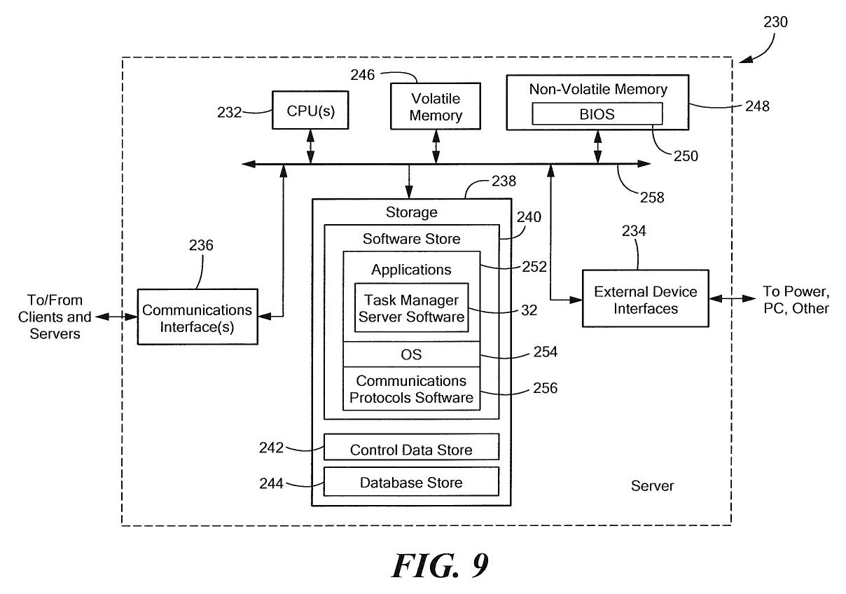

Referring to FIG. 9, one exemplary system for implementing the server side of the task manager (e.g., task manager service, etc.) includes a system such as system 230. The system 230 include at least one processing device, for example, one or more processors (e.g., CPUs) 232. Also included are various interfaces, including external device interfaces 234 to allow connections to external power devices and PCs (or other administrator consoles usable to configure various components of the SOA platform, such as policy and orchestration) and communication interfaces 236 (to enable the server to connect to and communicate with clients, and other servers or server groups). The system 230 includes: computer readable media in the form of storage such as hard disk storage 238 to store a software store 240, control data store 242, and database store 244; volatile memory 246; and nonvolatile memory 248 to store BIOS 250. The software store 240 includes applications 252, operating system 254 and communications protocols software 256 to support network communications. The applications 252 would include the task manager server software 32 (from FIG. 2) (e.g., SOA platform including task manager service 46, from FIG. 4) as well as other application programs. The software 240 would be copied to the volatile memory 246 (or internal processor memory) for subsequent execution by the processor 232. The various functional blocks of the system 230 are coupled to an internal bus structure, shown in simplified form as interconnect 258. The server system may have additional features or functionality.

The systems shown in FIGS. 8 and 9 are only simplified examples of a client device and server system, respectively, and are not intended to suggest any limitation as to the scope of use or functionality of their architectures. Also, it will be understood that the task manager software could reside entirely on the same physical device or system, whether that system is a server or a user device such as a handheld device that is configured to operate independently of a server. A user device may be appropriately configured to operate independently all of the time or part of the time. It should also be noted that tasking can still occur via the user's device when operated off-line (that is, without network connection). The communication of tasking information to task assignee will be transferred to the task assignee when the device is back “on-line”.

The task manager described herein provides a task management solution that can quite effectively support the task management needs of multi-user, multi-organizational and multi-echelon use. It is particularly advantageous for military command and control, as it gives the tactical command and control user greater visibility and control over tasks in a highly dynamic environment.

All references cited herein are hereby incorporated herein by reference in their entirety.

Having described preferred embodiments which serve to illustrate various concepts, structures and techniques which are the subject of this patent, it will now become apparent to those of ordinary skill in the art that other embodiments incorporating these concepts, structures and techniques may be used. Accordingly, it is submitted that that scope of the patent should not be limited to the described embodiments but rather should be limited only by the spirit and scope of the following claims.

What is claimed is:

1. A system comprising:
a task manager tool that enables a user operating in a first autonomous organization to assign tasks to and be assigned tasks by users operating in a second autonomous organization; and
wherein the task manager is configured so that all instances and elements of the task manager tool in the first autonomous organization are separate and independent from those of the task manager tool in the second autonomous organization.

2. The system of claim 1, wherein the task manager tool provides a user interface having an entry corresponding to each task.

3. The system of claim 2 wherein, in each entry, the task has a format that associates the task with task attributes including a task identifier and user-provided attributes.

4. The system of claim 3 wherein the user-provided attributes include a task originator, a task assignee, a task status and a task description.

5. The system of claim 4 wherein the task manager tool enables use of an unstructured text representation for the task description of some types of tasks and a structured data representation for the task description of other types of tasks.

6. The system of claim 4 wherein the task description is usable to create a task by, and to define a task to be executed at least in part by, other application software interoperable with the task manager tool and available to the task assignee.

7. The system of claim 4 wherein the task manager tool enables the task to be decomposed into subtasks.

8. The system of claim 7 wherein, when the task is decomposed into subtasks, the user interface includes entries for each subtask.

9. The system of claim 8 wherein the task originator and the task assignee of the decomposed task are the same or different.

10. The system of claim 9, wherein the task assignee of the decomposed task and the task assignee of each subtask are the same or different.

11. The system of claim 7 wherein, when the task is decomposed into subtasks, the user interface allows the task status of the decomposed task to indicate that the decomposed task is completed when all of the subtasks are completed.

12. The system of claim 2 wherein the task manager tool enables delegation of the task.

13. The system of claim 2 wherein the user interface provides a view of the tasks assigned to and by the user.

14. The system of claim 2 wherein the task manager tool allows a task result to be made available through use of the user interface.

15. The system of claim 2 wherein the task manager tool allows a reference to a task result to be made available through use of the user interface.

16. The system of claim 1 wherein the task manager tool enables use of planned tasks and prepared tasks.

17. The system of claim 1 further comprising a node associated with the first autonomous organization, the node being provided with the task manager tool and configured to connect to a second node associated with a second autonomous organization in a network.

18. The system of claim 17 wherein the node comprises a client device and a server coupled to the client device in a networked client/server arrangement, and wherein the task manager tool comprises task manager software and the networked client/server arrangement is configured with the task manager software.

19. The system of claim 18 wherein the task manager software comprises a first portion and a second portion, and wherein the client device is configured with client software that includes the first portion and the server is configured with server software that includes the second portion.

20. The system of claim 19 wherein the server software is implemented with a service oriented architecture (SOA) platform comprising a task manager service and other services.

21. The system of claim 20 wherein the other services comprise a policy/rules service to control release of information by the organization when a task result is to be provided via the task manager tool across organizational boundaries.

22. A method of exchanging task-related information in a multi-user, multi-organization environment, comprising:
enabling a user operating in a first autonomous organization to assign tasks to and be assigned tasks by users operating in a second autonomous organization through use of a task manager tool, the task manager tool being configured so that all instances and elements of the task manager tool in the first autonomous organization are separate and independent from those of the task manager tool of the second autonomous organization.

23. The method of claim 22 wherein enabling comprises providing a user interface having an entry corresponding to each task.

24. The method of claim 23 wherein, in each entry, the task is provided with a format that associates the task with task attributes including a task identifier and user-provided attributes.

25. The method of claim 24 wherein the user-provided attributes include a task originator, a task assignee, a task status and a task description.

26. The method of claim 25 wherein enabling further comprises using an unstructured text representation for the task description of some task types, and a structured data representation for the task description of other task types.

27. The method of claim 25 wherein the task description is usable to create a task by, and to define a task to be executed at least in part by, other application software interoperable with the task manager tool and available to the task assignee.

28. The method of claim 25 wherein enabling further comprises using the task manager tool to decompose the task into subtasks.

29. The method of claim 28 wherein, when the task is decomposed into subtasks, the user interface includes entries for each subtask.

30. The method of claim 29 wherein the task originator and the task assignee of the decomposed task are the same or different.

31. The method of claim 29 wherein the task assignee of the decomposed task and the task assignee of each subtask are the same or different.

32. The method of claim 28 wherein enabling further comprises updating the task status of the decomposed task to indicate that it is completed when all of the one or more subtasks are completed.

33. The method of claim 23 wherein the task manager allows the task to be delegated.

34. The method of claim 23 wherein providing the user interface comprises providing the user a view of the tasks assigned to and by the user.

35. The method of claim 23 wherein enabling further comprises allowing a task result to be made available through use of the user interface.

36. The method of claim 23 wherein enabling further comprises allowing a reference to a task result to be made available through use of the user interface.

37. The method of claim 22 wherein the task manager enables use of planned tasks and prepared tasks.

38. The method of claim 22 wherein the task manager tool comprises task manager software residing at least in part on a server configured with server software, the server software being implemented with a service oriented architecture (SOA) platform comprising a task manager service and other services.

39. The method of claim 38 wherein the services comprise a policy/rules service and enabling further comprises using the policy/rules service to control release of information by the organization when a task result is to be provided via the task manager tool across organizational boundaries.

40. A computer program product comprising:
a storage medium having stored thereon instructions that when executed by a processor result in the following:
providing a task manager tool that enables users operating in a first autonomous organization to assign tasks to and be assigned tasks by users in a second autonomous organization, the task manager being configured so that all instances and elements of the task manager tool used by users operating in the first autonomous organization are separate and independent from those of the task manager tool used by users operating in the second autonomous organization.
